(19) United States
(12) Patent Application Publication
(10) Pub. No.: US 2005/0251859 A1
(43) Pub. Date: Nov. 10, 2005

(54) Method of monitoring and protecting a private network against attacks from a public network

(75) Inventors: Juergen Quittek, Heidelberg (DE); Martin Stiemerling, Heidelberg (DE); Dirk Westhoff, Heidelberg (DE)

Correspondence Address: YOUNG & THOMPSON, 745 SOUTH 23RD STREET, 2ND FLOOR, ARLINGTON, VA, 22202, US

(73) Assignee: NEC CORPORATION, TOKYO (JP)

(21) Appl. No.: 11/094,448

(22) Filed: Mar. 31, 2005

(30) Foreign Application Priority Data
Mar. 31, 2004 (DE) 102004016582.3

(51) Int. Cl. H04L 9/00

(52) U.S. Cl. 726/22

(57) ABSTRACT

A method of monitoring and protecting a network against attacks from a public network, particularly from the Internet, where the network includes a firewall and an attack detection system on the protected side of the firewall, which inspects data packets passing the firewall and installs protective policies at the firewall in case of detecting data packets representing an attack. Regarding high flexibility and quick adaptability to changing attack situations, the method is characterized in that the firewall is configured by the attack detection system in such a way that the attack detection system or a system co-operating with the attack detection system is provided information about data packets representing an attack.

### BACKGROUND OF THE INVENTION

1. Field of the Invention

The present invention relates to a method of monitoring and protecting a network against attacks from a public network, particularly from the Internet, where the network includes a firewall and—located on the protected side of the firewall—an attack detection system which examines the data packets passing the firewall and in case of observing data packets representing an attack, installs policies on the firewall to protect the network.

2. Description of the Related Art

Generic methods are well known in practice and regarding the drastic increase in attacks from the Internet on private and local networks respectively, their importance is growing more and more.

The core of the infrastructure of the Internet is a public network to which organizations and persons connect their own networks and devices. In general, these networks and devices form a closed unit, that will be referred to as private network and which is usually protected by a firewall against undesired traffic from the Internet.

Firewalls protect the regular operation of private networks by filtering incoming data packets. The firewall inspects each data packet trying to pass the firewall and checks the data packets against a lot of policies that can be established beforehand. The policies can, for example, be defined by a network administrator and can be adapted to special situations. Based on the actual policies established on the firewall, the firewall allows a data packet to pass it. If the content or the structure of a data packet contradicts the established policies, the firewall drops the data packet before it can enter the network to be protected.

Today, attack detection systems are used which are able to detect a large number of different attacks on the regular operation of networks and devices, in order to be able to face the multitude and complexity of attacks from the Internet on private networks. These attacks can be viruses, worms, unauthorized intrusions as well as denial of service (DoS) attacks, wherein the latter attacks aim at rendering basically accessible services inaccessible.

The first generation of attack detection systems was integrated into firewalls. Such systems observe all traffic reaching the firewall and block identified attacks by modifying the policies of the firewall accordingly.

Today s attack detection systems run a lot of very complex tasks. Consequently, these systems need computational power in a significant and not negligible extent. In addition, the systems have to be updated frequently in order to be able to react to new developments of attack variants. For these reasons, a separation of the firewall on one side and attack detection systems on the other side is usually preferred today. The attack detection system is preferably designed as an independent device that can be equipped and updated independently from the firewall.

For practical reasons, the attack detection system is placed on the protected side of the firewall. On the one hand, such a configuration means an enormous saving in computational capacity as the attack detection system only has to observe those data packets having passed the firewall and not those already being blocked due to the installed policies. Furthermore, if the attack detection system were placed on the unprotected side of the firewall, it would be very difficult for it to be sure which data packets would be blocked by the firewall and which would be allowed to pass.

If the attack detection system identifies an attack, it sends a configuration message to the firewall, wherein the configuration message comprises one or more policies that are appropriate for blocking an identified attack and hence for protecting the private network.

A typical example for an attack against a network is a so-called denial of service attack. Such an attack is characterized by sending a huge amount of requests to a server in a protected network. These requests are typically useless or illegal and only aim at overloading the server by their kind and number such that certain services become almost unavailable for regular users.

Within the scope of such an attack, the attacking packets can originate from exactly one device, which makes it relatively easy to block them without harming the other regular packets. However, if the attacking packets originate from a huge number of different devices, it may occur that it is not possible to separate the attacking packets from the regular packets. In this case the attack detection system installs policies within the firewall, which have the effect that regular packets are also blocked if they have something in common with the attacking packets. The worst case is that all the packets from the whole Internet, which belong to a certain service, are blocked in order to avoid an overload of the server.

In this context, it is difficult to prove the end of an attack. Only if the end of an attack can be detected without any doubts, the blocking policies that were installed to block the attack at the firewall beforehand can be taken off and so the blocked service can be made available again. Otherwise, a service would be no longer available after the first attack.

As described above, attack detection systems are usually located at the protected side of the firewall and they inspect only packets that have successfully passed the firewall. If the policies for blocking an attack were defined in such a way that all the packets belonging to an attack were blocked by the firewall, then the attack detection system will observe no more packets belonging to the attack as soon as the policies at the firewall become effective. So, with the known methods to control and protect networks against attacks from the Internet it is not possible to detect the end of an attack. In fact, it is rather a human operator who is needed to regularly monitor the incoming packets at the public side of the firewall after an attack has been detected and protecting policies have been installed at the firewall accordingly. If the operator cannot observe anymore packets that can be assigned to the attack, he/she can remove the installed policies from the firewall and so make the blocked service available again. The fact that a human operator is necessary makes the methods as known by today cost-intensive on the one hand and results in a very low flexibility of the procedures on the other hand.

### SUMMARY OF THE INVENTION

An objective of the present invention is to provide a method and a system to monitor a network and to protect it against attacks from a public network, particularly from the Internet, of the aforesaid kind with easy means and to develop it in such a way that a high flexibility is given and a quick detection of changing attack situations is possible.

The generic method according to the invention solves the problem by the characteristics of claim 1. According to the present invention, such a method is characterized by a configuration of the firewall by the attack detection system in such a way that the attack detection system or a system co-operating with it can be provided with information about data packets representing an attack for further analysis.

According to the invention, it has first been recognized that in the context of monitoring and protecting networks, it is not sufficient to block attacking packets by policies installed in the firewall, as in some cases important information gets lost and an efficient operation of the network is hindered. Due to the invention, it is rather proposed to configure the firewall by the attack detection system in such a way that information about data packets belonging to an attack, is sent to the attack detection system for further analysis.

Alternatively, the information is sent to a system co-operating with the attack detection system. Due to the information provided, the method according to the invention is able to identify changing attack situations quickly. Furthermore, the method according to the invention is easy to implement and can be realized with low efforts and it reduces the need of manual interaction in case of an attack considerably.

As not only the identification of an attack, but also the detection of an end of an attack is often of outstanding importance, it can be provided that the information sent to the attack detection system or a system co-operating with it, is analyzed with the special focus on detecting the end of an attack. By these means the end of an attack can be detected on the protected side of the firewall without manual assistance.

### BRIEF DESCRIPTION OF THE DRAWINGS

FIG. 1 is a diagram showing a system according to an embodiment of the present invention.

### DESCRIPTION OF THE PREFERRED EMBODIMENTS

In a particularly preferred embodiment, a feedback is provided in such a way that depending on the information provided to the attack detection system or its cooperating system, policies installed at the firewall and protecting the private network can be adapted and/or deleted. In other words, the firewall can be reset automatically to a normal, less protected state of operation, as soon as the information provided to the attack detection system indicates an end of an attack. In particular, the policies provided solely for the defense against a—finished—attack can be removed from the firewall. The option of an automatic removal of the policies at the firewall which were provided as protection against an attack is particularly advantageous in cases when the installed policies do not only block the attack, but also the regular data traffic. In this way the availability of services is increased by removing the blockade of packets as soon as possible.

In a particular embodiment which is very easy to implement, the firewall can be configured by the attack detection system in such a way that data packets representing an attack against the private network are sent completely to the attack detection system or to its respective co-operating system. In order to avoid unnecessarily heavy data traffic, also just pre-selected parts of the attacking data packets can be redirected instead of the whole data packets. It can be envisaged, for example, to redirect only the headers of the data packets containing information that is usually relevant, such as origin, destination and size of a packet.

In a specific embodiment, redirecting of data packets or parts of the data packets can be performed by a network address translation of the destination address. In this case, the destination address in the header of the packet is replaced by the destination address of the attack detection system or its respective co-operating system.

To preserve the original destination address of the attacking packet, it is extremely advantageous to encapsulate the attacking packets into packets transporting the attacking packets. By doing so, the whole information contained in the attacking packet is kept unmodified. By such an encapsulation the reservation of Internet addresses at the attack detection system, which would be necessary in case of a network address translation, becomes obsolete. Even though attacking packets can use several transport protocols such as TCP, UDP and ICMP (Internet Control Message Protocol) with any port number, they can consequently be used for further communication by the attack detection system.

The easiest case is an encapsulation by an IP-over-IP-encapsulation wherein every attacking packet gets an additional header showing the address of the attack detection system or its respective co-operating system as destination address.

Instead of an IP-over-IP-encapsulation, the redirection of data packets or a part of the data packets can be performed by encapsulation within one or more UDP (User Datagram Protocol)-data packets. In this case, the redirected packets are delivered to a selected target address of the attack detection system or its respective cooperating system at an agreed UDP port number.

Particularly preferred is the encapsulation into a TCP (Transmission Control Protocol) data stream as this system disposes of mechanisms of flow control. A temporary overload of the attack detection system due to a too large number of redirected packets can therefore effectively be dealt with by applying appropriate countermeasures. Furthermore, the use of a TCP-data stream avoids that packets get lost during transportation without recognizing this loss at their origin or destination.

Multiple alternatives of redirection can be envisaged. The information can be transmitted as Ethernet frames to the attack detection system or its respective cooperating system. Alternatively to using the TCP or UDP transport protocols, many other transport protocols, such as SCTP (Stream Control Transmission Protocol) or DCCP (Datagram Congestion Control Protocol), can additionally be used.

In case of massive attacks, it is beneficial to perform the redirection over a separate physical line dedicated for this only purpose in order to avoid—due to a large number of redirected attacking packets—an exaggerated load on the network to be protected. By using a separate network connection, no attacking packets that impact the network and the regular network traffic by additional load, will appear in the network to be protected.

For further reduction of the upcoming data volume the packets are compressed in an advantageous way before redirecting them. This can happen by any of the known methods for compressing data.

In case that the analysis at the attack detection system or at its respective cooperating system shows that a packet falsely regarded to be an attacking one, is not such an attacking one, it can be provided that the respective packet is sent to the original destination address. By doing so the normal data traffic is least affected and reduced.

In an embodiment that is very efficient regarding the required resources, it is provided that the firewall is configured by the attack detection system in such a way that packets representing an attack are blocked by the firewall and that the attack detection system or its respective co-operating system will be informed about the exact number of packets blocked by the firewall. In addition, information concerning the size of every single data packet blocked and/or concerning the sum of the sizes of all the blocked data packets can be transmitted. For practical reasons information concerning sizes will be transmitted in configurable, preferably regular, time intervals. This method is a good choice for many cases, as there are multiple kinds of attacks for which only the number of blocked packets per period indicates the end of the attack. Using such a method is particularly a good choice if the data volume represents a critical factor due to limited resources, as the load caused by this method is significantly less than the load that would be created by redirecting the packets to the attack detection system. In addition, it costs much less effort to observe the counters for packets and amounts of data regularly than inspecting the attacking packets continuously themselves.

Regarding high flexibility, it can be provided that the information provided to the attack detection system or its co-operating system will be analyzed by the aid of configurable, i.e. in particular changeable and adjustable, parameters. For some specific attacks it can be advantageous to analyze the provided information concerning the determination of the source of the attack. In addition, statistics of the attacks can be built up on the base of the analyzed information, which can lead to a better understanding of the attacks on one hand and to a development of farther reaching defense strategies on the other hand.

There are several options of how to design and to further develop the teaching of the present invention in an advantageous way. For this purpose, it is to be referred to the claims subordinate to independent claim 1 on the one hand and to the following explanation of the preferred example of an embodiment of the invention illustrated by the figure on the other hand. In connection with the explanation of the preferred example of an embodiment of the invention according to the figure, preferred embodiments and further developments of the teaching will be explained in general.

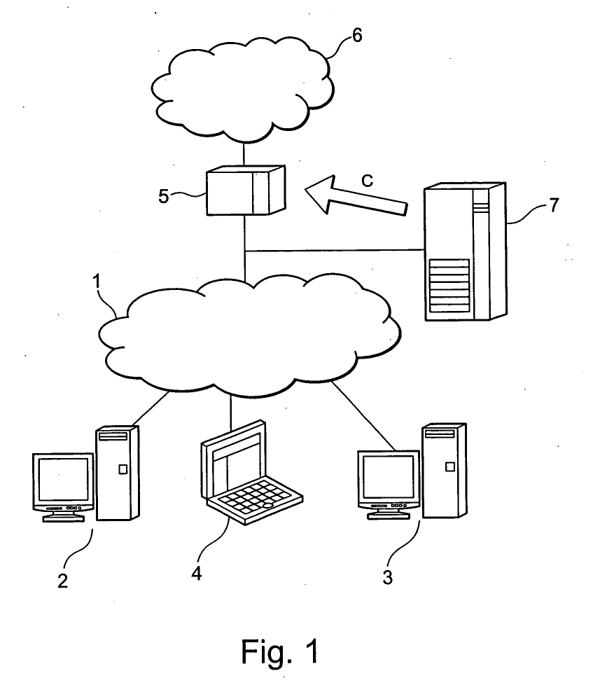

FIG. 1 shows a scheme of an example of an embodiment of a method to control and protect a network according to the present invention.

A network 1 which is to be protected comprises a multitude of hardware systems being in detail a server 2, a simple desktop computer 3.or notebooks 4, for example. The network 1 comprises in addition a firewall 5 separating the network 1 to be protected from the public Internet 6. On the protected side of the firewall 5 there is an attack detection system 7 inspecting the data packets passing the firewall 5 and, in case of detecting data packets representing an attack, installing policies on the firewall 5 protecting the network 1.

The firewall 5 is configured by the attack detection system 7 in such a way that the attack detection system 7 is provided information about packets representing a possible attack for further analysis. This information may be, for example, the whole data packets, the headers of the data packets indicating the source, the destination and size of the packets, the amount of data, or the number of packets. Depending on this information, the attack detection system 7 can adapt and/or remove policies installed at the firewall 5, which protect the network 1. This configuration of the firewall 5 by the attack detection system 7 is indicated by the arrow marked with a C as shown in FIG. 1. The attack detection system 7 can, for example, automatically adapt the policies protecting the network 1 at the firewall 5 after detecting the end of an attack in such a way that the adapted status is taken into consideration, in particular in such a way that only the policy elements used for defending the finished attack are removed from the firewall 5.

Finally, it is particularly pointed out that the described example of an embodiment only serves as an illustration of the claimed teaching, but that it does by no means restrict the latter to the given example of embodiment.

1. A method for monitoring and protecting a network against attacks from a public network where the network includes a firewall and an attack detection system which is located on the protected side of the firewall, the method comprising:
the attack detection system inspecting data packets passing the firewall; and
when detecting attacking data packets, the attack detection system installing policies on the firewall protecting the network, wherein the firewall is configured by the attack detection system in such a way that the attack detection system or a system co-operating with the attack detection system is provided with information for further analysis about data packets representing an attack.

2. The method according to claim 1, wherein the information provided for detecting the end of an attack is analyzed by the attack detection system or a system co-operating with the attack detection system.

3. The method according to claim 1, wherein the policies which are installed at the firewall and which protect the network are adapted and/or removed depending on the information provided for the attack detection system or a system co-operating with the attack detection system.

4. The method according to claim 2, wherein the policies which are installed at the firewall and which protect the network are adapted and/or removed depending on the information provided for the attack detection system or a system co-operating with the attack detection system.

5. The method according to claim 1, wherein the firewall is configured by the attack detection system in such a way that the data packets representing an attack are redirected entirely to the attack detection system or a system co-operating with the attack detection system.

6. The method according to claim 1, wherein the firewall is configured by the attack detection system in such a way that only pre-selected parts of the data packets representing an attack, preferably the headers of the data packets, are redirected to the attack detection system or to a system co-operating with the attack detection system.

7. The method according to claim 5, wherein the redirection of the data packets is performed by network address translation of the destination address of the data packets.

8. The method according to claim 6, wherein the redirection of the data packets or of parts of the data packets is performed by network address translation of the destination address of the data packets.

9. The method according to claim 5, wherein the redirection of the data packets is performed by transmission through an IP (Internet Protocol) tunnel.

10. The method according to claim 6, wherein the redirection of the data packets or of parts of the data packets is performed by transmission through an IP (Internet Protocol) tunnel.

11. The method according to claim 5, wherein the redirection of the data packets is performed by encapsulation into one or several UDP (User Datagram Protocol) data packets.

12. The method according to claim 6, wherein the redirection of the data packets or of parts of the data packets is performed by encapsulation into one or several UDP (User Datagram Protocol) data packets.

13. The method according to claim 5, wherein the redirection of the data packets is performed by encapsulation into a TCP (Transmissions Control Protocol) data stream.

14. The method according to claim 6, wherein the redirection of the data packets or of parts of the data packets is performed by encapsulation into a TCP (Transmissions Control Protocol) data stream.

15. The method according to claim 5, wherein the redirection of the data packets is performed by a transmission as Ethernet frames or by the SCTP (Stream Control Transmission Protocol), the DCCP (Datagram Congestion Control Protocol) or similar transport protocols.

16. The method according to claim 6, wherein the redirection of the data packets or of parts of the data packets is performed by a transmission as Ethernet frames or by the SCTP (Stream Control Transmission Protocol), the DCCP (Datagram Congestion Control Protocol) or similar transport protocols.

17. The method according to claim 5, wherein the redirection of the data packets is performed by transmission over a separate physical line reserved for this purpose.

18. The method according to claim 6, wherein the redirection of the data packets or parts of the data packets is performed by transmission over a separate physical line reserved for this purpose.

19. The method according to claim 5, wherein the data packets are compressed before redirection.

20. The method according to claim 6, wherein the data packets are compressed before redirection.

21. The method according to claim 1, wherein data packets which do not represent an attack, are sent to their original destination address by the attack detection system or a system co-operating with the attack detection system after having analyzed them.

22. The method according to claim 1, wherein the firewall is configured by the attack detection system in such a way that the data packets representing an attack are blocked by the firewall and that information regarding the number of the blocked data packets is sent to the attack detection system or to a system co-operating with the attack detection system.

23. The method according to claim 22, wherein the attack detection system or a system co-operating with the attack detection system is provided with information about the size of every single blocked data packet and/or about the sum of the size of all the blocked data packets.

24. The method according to claim 23, wherein the attack detection system or a system co-operating with the attack detection system is provided the information in configurable, preferably regular, time intervals.

25. The method according to claim 23, wherein the information provided to the attack detection system or a system co-operating with the attack detection system is analyzed according to configurable parameters.

26. The method according to claim 1, wherein the information provided to the attack detection system or to a system co-operating with the attack detection system is analyzed to identify the source of an attack.

27. The method according to claim 1, wherein the information provided to the attack detection system or a system co-operating with the attack detection system is utilized for producing attack statistics.

28. A system for monitoring and protecting a network against attacks from a public network, comprising:
a firewall; and
an attack detection system which is located on the protected side of the firewall, wherein the attack detection system inspects data packets passing the firewall and, when detecting attacking data packets, installs policies on the firewall protecting the network,
wherein the firewall is configured by the attack detection system in such a way that the attack detection system or a system co-operating with the attack detection system is provided with information for further analysis about data packets representing an attack.
